(19) United States
(12) Patent Application Publication
(10) Pub. No.: US 2016/0327193 A1
(43) Pub. Date: Nov. 10, 2016

(54) WATER-SEAL CONNECTOR AND AN AIR-CONDITIONING DEVICE WITH THE SAME

(71) Applicant: NEW WIDETECH INDUSTRIES CO., LTD., New Taipei (TW)

(72) Inventor: Ming-Tsung CHIU, New Taipei City (TW)

(73) Assignee: NEW WIDETECH INDUSTRIES CO., LTD., New Taipei (TW)

(21) Appl. No.: 14/707,381

(22) Filed: May 8, 2015

(51) Int. Cl. F16L 25/00; F25D 21/14; F16L 25/06

(52) U.S. Cl. CPC F16L 25/009; F16L 25/0018; F16L 25/06; F25D 21/14

(57) ABSTRACT

A draining unit of a water-seal connector has a first fixing base, a second fixing base, a first sealing component, a soft base, a third fixing base, a second sealing component, a connecting cover, and an adaptor component. The second fixing base is connected to the first fixing base and has a first gateway communicating with the first fixing base and a second connecting part formed on the second fixing base. The first sealing component is mounted through the second fixing base. The soft base aligns with the second connecting part. The third fixing base is held in the soft base. The second sealing component is mounted through the third fixing base. The connecting cover is mounted on the soft base. The adaptor component is mounted securely in the connecting cover and has an outer connecting part extending out of the connecting cover.

### BACKGROUND OF THE INVENTION

1. Field of the Invention

The present invention relates to a water-seal connector and an air-conditioning device with the same, especially a water-seal connector applied to a mobile air-conditioning device.

2. Description of the Prior Arts

Conventional air-conditioning devices include multiple types such as air conditioners, heaters, and dehumidifiers. The different types of air-conditioning devices have various effects for adjusting interior temperature, humidity, air cleanness and recycling the air in an indoor environment. The air conditioner provides cool air to lower the interior temperature. With coolant and compressor, the heater evaporates the interior air for raising the temperature and the dehumidifier condenses the interior air for dropping the humidity. The above-mentioned conventional air conditioning devices are of stationary type and are always installed at an interior place. Mobile air-conditioning devices are developed for improving the convenience. The air-conditioning device produces condensed water during the operating process, and a draining pipe is connected to the device for drainage. The conventional mobile air-conditioning device has a water reservoir unit mounted therein. The water reservoir unit collects the condensed water and has a draining pipe. After the water reservoir unit collects a specific quantity of condensed water, the condensed water is drained away from the draining pipe to a bathroom or an outdoor place. But the water level of the draining pipe will be changed by a door sill or other barriers, so the condensed water is unable to be drained completely and some of the condensed water remains in the water reservoir unit. For draining the condensed water completely, the mobile air-conditioning device must be moved to the outdoor place to discharge water by opening a draining hole disposed in a bottom of the mobile air-conditioning device.

To overcome the shortcomings, the present invention provides a water-seal connector to mitigate or obviate the aforementioned problems.

### SUMMARY OF THE INVENTION

The main objective of the present invention is to provide a water-seal connector applied to a mobile air-conditioning device to improve draining of condensed water produced by the mobile air-conditioning device. So the mobile air-conditioning device would not stop operating when condensed water reaches full capacity.

The water-seal connector comprises a first fixing base, a second fixing base, a first sealing component, a soft base, a third fixing base, a second sealing component, a connecting cover, and an adaptor component.

The second fixing base is connected to the first fixing base and has a first gateway and a second connecting part. The first gateway is disposed in the second fixing base and communicates with the first fixing base. The second connecting part is formed on an outer wall of the second fixing base distal from the first fixing base. The first sealing component is movably mounted through the second fixing base, selectively seals the first gateway, and has a first spring abutting the second fixing base and the first sealing component. The soft base aligns with the second connecting part and has an outer surface, an outer wall, and a soft connecting part. The soft connecting part is formed on the outer wall of the soft base and is detachably mounted around the second connecting part of the second fixing base. The third fixing base is held in the soft base and has a second gateway. The second gateway is formed on a side wall of the third fixing base and is distal from the first sealing component. The second gateway communicates with the soft base and the second connecting part. The second sealing component is movably mounted through the third fixing base, selectively seals the second gateway, and has a second spring abutting the third fixing base and the second sealing component. The connecting cover is mounted around an outer surface of the soft base. The adaptor component is mounted securely in the connecting cover and has an outer connecting part. The outer connecting part is formed on the adaptor component and extends out of the connecting cover.

When the second connecting part of the second fixing base is mounted tightly in the soft connecting part of the soft base, the first sealing component and the second sealing component abut against each other and respectively press the first spring and the second spring, so the first gateway of the second fixing base and the second gateway of the third fixing base communicate with each other for draining the condensed water.

Other objectives, advantages and novel features of the invention will become more apparent from the following detailed description when taken in conjunction with the accompanying drawings.

### BRIEF DESCRIPTION OF THE DRAWINGS

FIG. 1 is a perspective side view of a water-seal connector in accordance with the present invention;

FIG. 2 is an exploded perspective view of the water-seal connector in

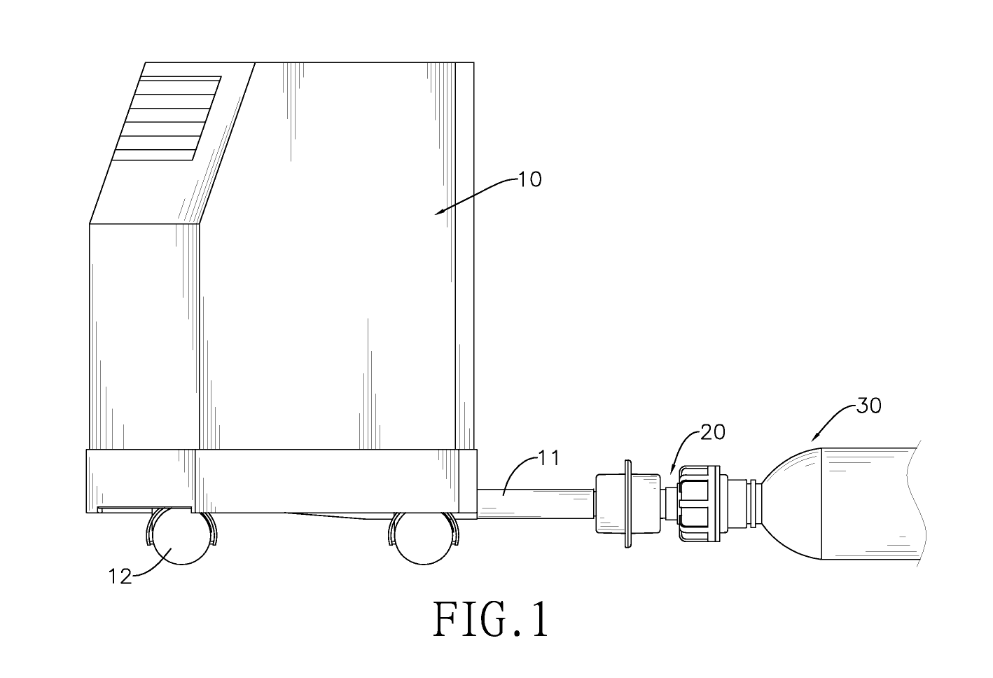

FIG. 1;

FIG. 3 is a partially enlarged perspective view of a second fixing base of the water-seal connector in FIG. 1;

FIG. 4 is a partially enlarged perspective view of a third fixing base of the water-seal connector in FIG. 1;

FIG. 5 is an enlarged cross-sectional side view of a draining unit of the water-seal connector in FIG. 1, shown separated from the water-seal connector;

FIG. 6 is an enlarged cross-sectional side view of the draining unit of the water-seal connector in FIG. 1, shown assembled with the water-seal connector; and

FIG. 7 is an enlarged cross-sectional side view of the water-seal connector in FIG. 1, shown assembled with a water reservoir unit.

### DETAILED DESCRIPTION OF THE PREFERRED EMBODIMENTS

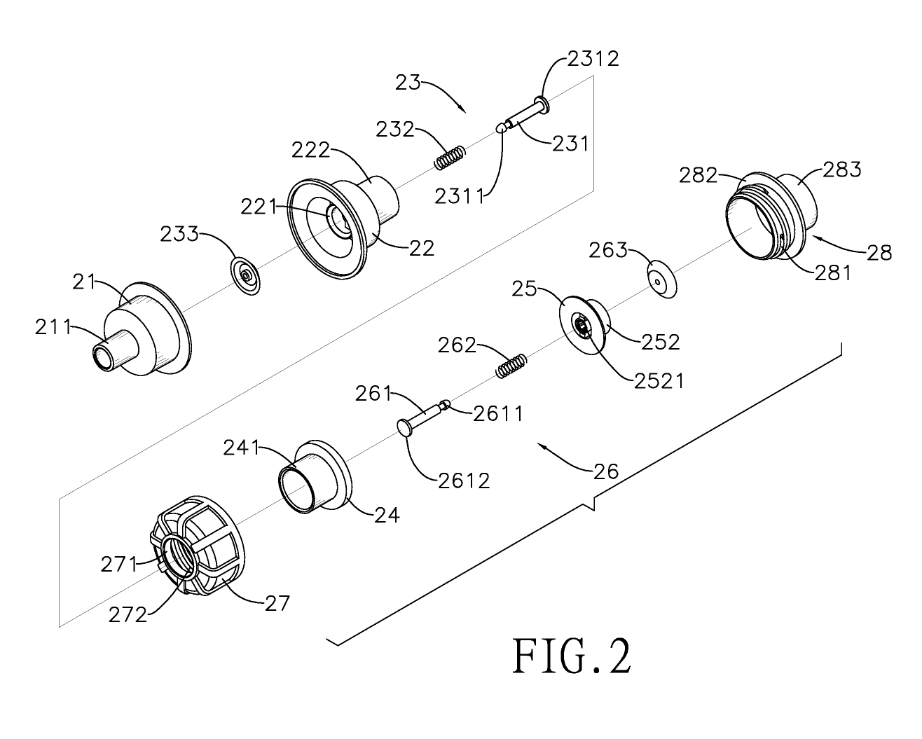

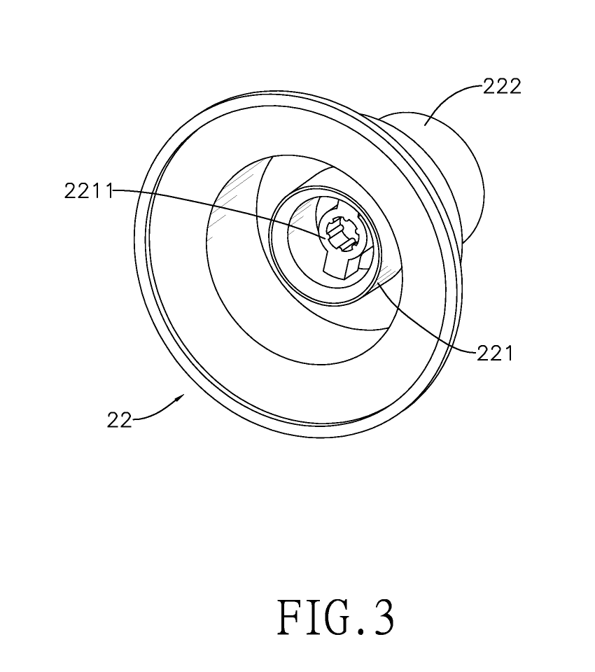

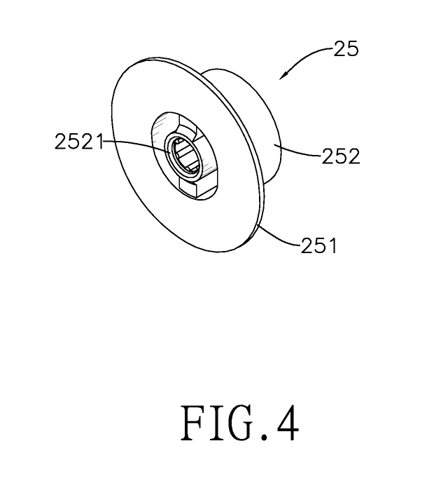

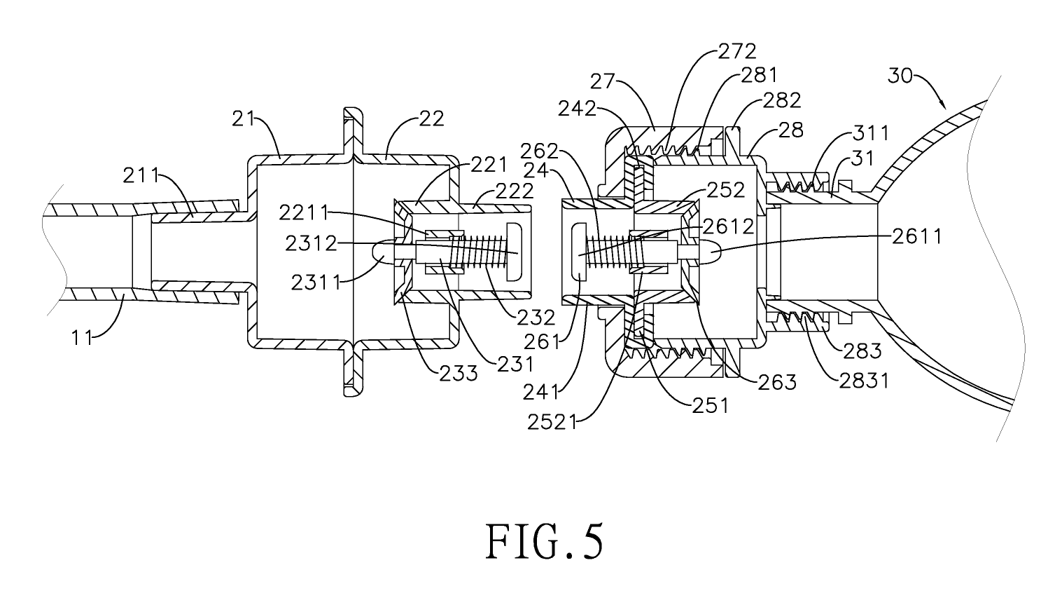

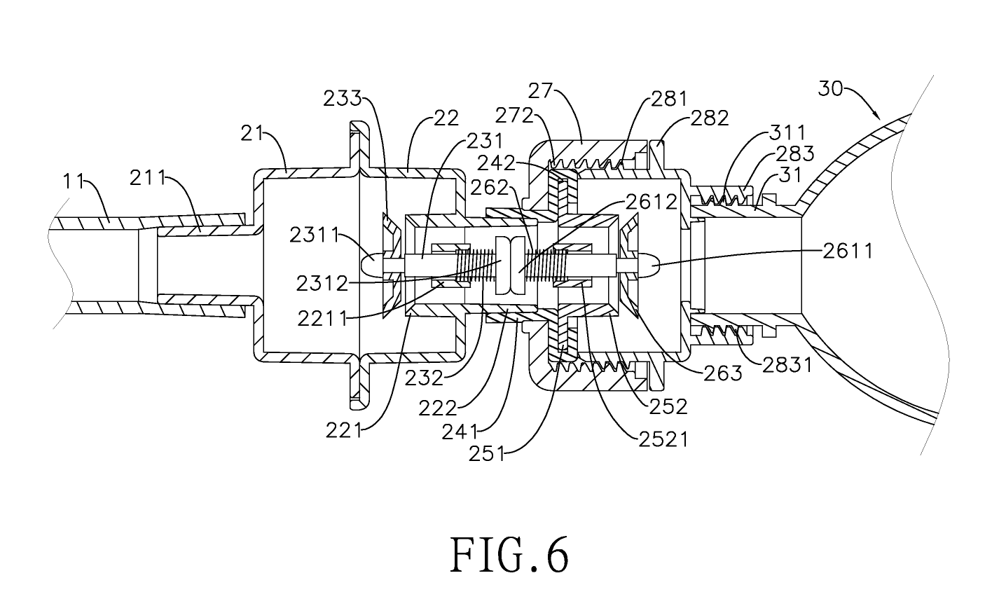

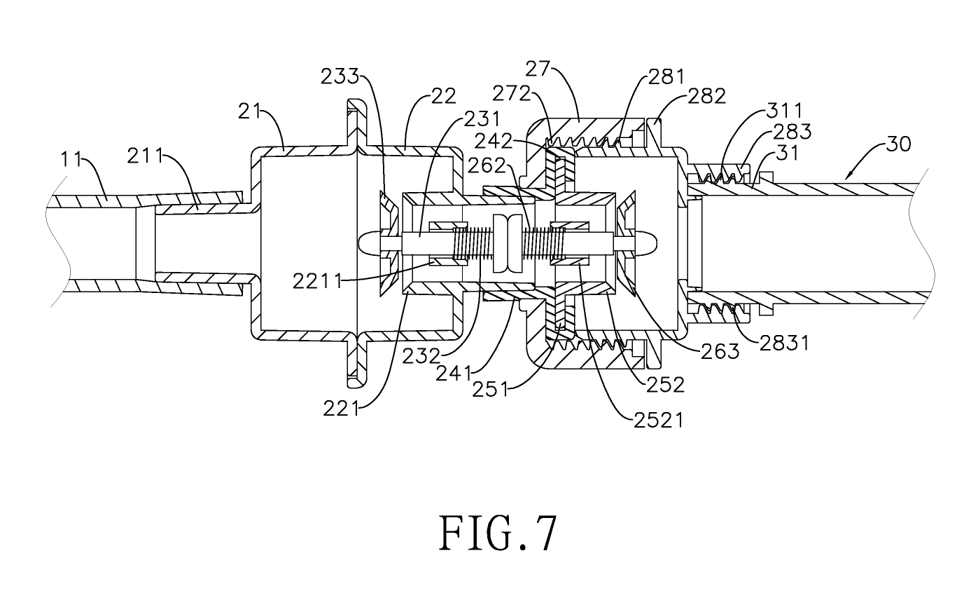

With reference to FIGS. 1 to 2, a water-seal connector in accordance with the present invention is connected to an air conditioning unit 10 and a water reservoir unit 30 and comprises a draining unit 20.

With reference to FIGS. 1 to 4, the air conditioning unit 10 has an outer wall, a bottom side, a drain pipe 11, and multiple wheels 12. The drain pipe 11 is mounted on the outer wall near the bottom side of the air conditioning unit 10. The wheels 12 are mounted on a bottom of the air conditioning unit 10 for mobility.

The draining unit 20 is connected to the air conditioning unit 10 and has a first fixing base 21, a second fixing base 22, a first sealing component 23, a soft base 24, a third fixing base 25, a second sealing component 26, a connecting cover 27, and an adaptor component 28. The first fixing base 21 is connected to the air conditioning unit 10 and has a first connecting part 211. The first connecting part 211 is formed on an outer wall of the first fixing base 21 and faces the air conditioning unit 10. The first connecting part 211 communicates with the drain pipe 11. The second fixing base 22 is connected to the first fixing base 21. In a preferred embodiment, the second fixing base 22 is attached to the first fixing base 21. The second fixing base 22 has an outer wall, a first gateway 221, and a second connecting part 222. The first gateway 221 is disposed in the second fixing base 22 and communicates with the first fixing base 21. The first gateway 221 has an inner surface and a first positioning sleeve 2211 formed on the inner surface. The second connecting part 222 is formed on the outer wall of the second fixing base 22 distal from the first fixing base 21. The second fixing base 22 aligns with the first gateway 221.

The first sealing component 23 is mounted in the second fixing base 22 and has a first plug 231, a first spring 232, and a first seal lock 233. The first plug 231 is mounted in the first positioning sleeve 2211 of the first gateway 221 and has two sides, a fastening part 2311, and a pushing part 2312. The fastening part 2311 and the pushing part 2312 are respectively formed on the sides of the first plug 231. The fastening part 2311 is located outside of the first gateway 221 and the pushing part 2312 is located in the second connecting part 222. The first spring 232 is mounted around the first plug 231 and respectively abuts the first positioning sleeve 2211 and the pushing part 2312. The first seal lock 233 is mounted around the first plug 231 and contacts the fastening part 2311, and the first seal lock 233 seals the first gateway 221.

The soft base 24 has an outer wall, an outer surface, a soft connecting part 241, and an inner annular groove 242. The soft connecting part 241 is formed on the outer wall of the soft base 24 and is detachably mounted around the second connecting part 222 of the second fixing base 22. An internal diameter of the soft connecting part 241 is smaller than an external diameter of the second connecting part 222. The inner annular groove 242 is concaved in the soft base 24 and is distal from the soft connecting part 241. The third fixing base 25 is connected to the soft base 24 and has an edging surface, a side wall, an outer annular flange 251, and a second gateway 252. The outer annular flange 251 is formed on the edging surface of the third fixing base 25 and is held in the inner annular groove 242 of the soft base 24. The second gateway 252 is formed on the side wall of the third fixing base 25 distal from the first sealing component 23. The second gateway 252 has an inner surface and a second positioning sleeve 2521 formed on the inner surface. The second gateway 252 communicates with the soft connecting part 241 and the second connecting part 222.

The second sealing component 26 is mounted in the soft base 24 and the third fixing base 25. The second sealing component 26 has a second plug 261, a second spring 262, and a second seal lock 263. The second plug 261 is mounted in the second positioning sleeve 2521 of the second gateway 252 and has two sides, a fastening part 2611, and a pushing part 2612. The fastening part 2611 and the pushing part 2612 are respectively formed on the sides of the second plug 261. The fastening part 2611 is located outside of the second gateway 252 and the pushing part 2612 is located in the soft connecting part 241. The second spring 262 is mounted around the second plug 261 and respectively abuts the second positioning sleeve 2521 and the pushing part 2612. The second seal lock 263 is mounted around the second plug 261 and contacts the fastening part 2611, and the second seal lock 263 seals the second gateway 252. The connecting cover 27 is mounted around the outer surface of the soft base 24 and has an inner annular surface, a hole 271, and an inner thread 272. The soft connecting part 241 is mounted in the hole 271 and through the connecting cover 27. The inner thread 272 is formed on the inner annular surface.

The adaptor component 28 is mounted securely in the connecting cover 27 and has an outer round surface, an adaptor outer thread 281, an annular limiting flange 282, and an outer connecting part 283. The adaptor outer thread 281 is formed on the outer round surface of the adaptor component 28. The adaptor outer thread 281 is screwed with the inner thread 272 of the connecting cover 27 for securing the soft base 24 and the third fixing base 25. The annular limiting flange 282 is formed on the outer round surface and near the adaptor outer thread 281. The annular limiting flange 282 covers the connecting cover 27. The outer connecting part 283 is formed on the adaptor component 28 and extends out of the connecting cover 27. The outer connecting part 283 has an inner face and an adaptor inner thread 2831 formed on the inner face.

With reference to FIGS. 6 to 7, the water reservoir unit 30 communicates with the draining unit 20 and has an external wall and a locking part 31. In a preferred embodiment, the water reservoir unit 30 is a hollow container or a water pipe. The locking part 31 is formed on the external wall of the water reservoir unit 30. The locking part 31 is mounted in the adaptor component 28 and communicates with the second gateway 252 of the third fixing base 25. The locking part 31 has an outer thread 311 screwed with the adaptor inner thread 2831 of the outer connecting part 283.

With reference to FIGS. 5 and 6, the draining unit 20 is connected to the drain pipe 11 of the air conditioning unit 10 and the locking part 31 of the water reservoir unit 30. The draining unit 20 is normally closed. When the air conditioning unit 10 and the water reservoir unit 30 are separated, the pushing part 2312 of the first plug 231 abuts the first spring 232, and the first seal lock 233 seals the first gateway 221 of the second fixing base 22. The condensed water in the air conditioning unit 10 will not leak from the drain pipe 11 and the first gateway 221. In addition, the pushing part 2612 of the second plug 261 abuts the second spring 262, and the second seal lock 263 seals the second gateway 252 of the third fixing base 25. The condensed water in the water reservoir 30 will not leak from the locking part 31 and the second gateway 252.

For connecting the air conditioning unit 10 and the water reservoir unit 30, the second connecting part 222 of the second fixing base 22 is mounted tightly in the soft connecting part 241 of the soft base 24. The pushing part 2312 of the first plug 231 of the first sealing component 23 and the pushing part 2612 of the second plug 261 of the second sealing component 26 abut against each other. The pushing parts 2312, 2612 respectively press the first spring 232 and the second spring 262. The fastening parts 2311, 2611 of the first plug 231 and the second plug 261 move toward opposite directions, and then the first seal lock 233 and the second seal lock 263 are respectively removed from the first gateway 221 and the second gateway 252. So the air conditioning unit 10 and the water reservoir unit 30 communicate with each other for draining the condensed water. When assembled with the air conditioning unit 10, the draining unit 20 could easily drain the condensed water produced by the air conditioning unit 10. So the air conditioning device would not stop operating when the condensed water reaches full capacity.

With reference to FIGS. 6 and 7, the present invention is connected to a hollow container or a water pipe by using the adaptor component 28 of the draining unit 20. The hollow container collects the condensed water produced by the air conditioning unit 10. Users could remove the hollow container to discharge the condensed water after the hollow container is filled with condensed water. The water pipe could drain the condensed water to a scupper or a tank. When the hollow container is in use, the draining process will not be affected by a door sill or other barriers, so the condensed water can be drained completely. The water-seal connector can be connected to various containers and water pipes.

Even though numerous characteristics and advantages of the present invention have been set forth in the foregoing description, together with details of the structure and features of the invention, the disclosure is illustrative only.

Changes may be made in the details, especially in matters of shape, size, and arrangement of parts within the principles of the invention to the full extent indicated by the broad general meaning of the terms in which the appended claims are expressed.

What is claimed is:

1. A water-seal connector comprising:
a first fixing base;
a second fixing base connected to the first fixing base and having
an outer wall;
a first gateway disposed in the second fixing base and communicating with the first fixing base; and
a second connecting part formed on the outer wall of the second fixing base distal from the first fixing base;
a first sealing component movably mounted through the second fixing base, selectively sealing the first gateway, and having
a first spring abutting the second fixing base and the first sealing component;
a soft base aligning with the second connecting part and having
an outer surface;
an outer wall; and
a soft connecting part formed on the outer wall of the soft base and detachably mounted around the second connecting part of the second fixing base, an internal diameter of the soft connecting part being smaller than an external diameter of the second connecting part of the second fixing base;
a third fixing base held in the soft base and having
a side wall; and
a second gateway formed on the side wall of the third fixing base distal from the first sealing component and communicating with the soft base and the second connecting part;
a second sealing component movably mounted through the third fixing base, selectively sealing the second gateway, and having
a second spring abutting the third fixing base and the second sealing component;
a connecting cover mounted around the outer surface of the soft base; and
an adaptor component mounted securely in the connecting cover and having
an outer connecting part formed on the adaptor component and extending out of the connecting cover;
wherein when the second connecting part of the second fixing base is mounted tightly in the soft connecting part of the soft base, the first sealing component and the second sealing component abut against each other and respectively press the first spring and the second spring, so the first gateway of the second fixing base and the second gateway of the third fixing base communicate with each other for draining water.

2. The water-seal connector as claimed in claim 1, wherein
the first gateway of the second fixing base has
an inner surface; and
a first positioning sleeve formed on the inner surface of the first gateway;
the first spring is mounted around the first sealing component and abuts the first positioning sleeve;
the second gateway of the third fixing base has
an inner surface; and
a second positioning sleeve formed on the inner surface of the second gateway and communicating with the soft connecting part; and
the second spring is mounted around the second sealing component and abuts the second positioning sleeve.

3. The water-seal connector as claimed in claim 2, wherein
the first sealing component has
a first plug mounted in the first positioning sleeve of the first gateway and having
two sides; and
a fastening part formed on one of the sides of the first plug and disposed outside of the first gateway;
a first seal lock securely mounted around the first plug and selectively sealing the first gateway;
the first spring is mounted around the first plug and abuts the fastening part of the first plug;
the second sealing component has
a second plug mounted in the second positioning sleeve of the second gateway and having
two sides, and
a fastening part formed on one of the sides of the second plug and disposed outside of the second gateway;
a second seal lock securely mounted around the second plug and selectively sealing the second gateway; and
the second spring is mounted around the second plug and abuts the fastening part of the second plug.

4. The water-seal connector as claimed in claim 1, wherein
the soft base has
an inner annular groove concaved in the soft base and distal from the soft connecting part; and
the third fixing base has
an outer annular flange formed annularly around the third fixing base and held in the inner annular groove of the soft base.

5. The water-seal connector as claimed in claim 1, wherein
the connecting cover is mounted on the outer surface of the soft base and has
an inner annular surface; and
an inner thread formed on the inner annular surface;
the adaptor component has
an outer round surface;
an adaptor outer thread formed on the outer round surface of the adaptor component and screwed with the inner thread of the connecting cover for securing the soft base between the adaptor component and the connecting cover; and
an annular limiting flange formed on the outer round surface and abutting the connecting cover.

6. The water-seal connector as claimed in claim 5, wherein
the outer connecting part has
an inner face; and
an adaptor inner thread formed on the inner face of the outer connecting part.

7. The water-seal connector as claimed in claim 1, wherein the second fixing base aligns with the first gateway.

8. The water-seal connector as claimed in claim 1, wherein
the first fixing base has
an outer wall; and
a first connecting part formed on the outer wall of the first fixing base.

9. An air-conditioning device with a water-seal connector as claimed in claim 1, comprising:
an air conditioning unit having
an outer wall;
a bottom side; and
a drain pipe mounted on the outer wall near the bottom side of the air conditioning unit;
a water reservoir unit having
an external wall; and
a locking part formed on the external wall;
wherein the water-seal connector is connected between and communicates with the drain pipe of the air conditioning unit and the locking part of the water reservoir unit.

10. The air-conditioning device as claimed in claim 9, wherein
the drain pipe of the air conditioning unit is connected to and communicates with the first fixing base of the water-seal connector; and
the locking part of the water reservoir is mounted in the adaptor component of the water-seal connector and communicates with the second gateway of the third fixing base of the water-seal connector.
